(19) United States
(12) Patent Application Publication
(10) Pub. No.: US 2026/0339401 A1
(43) Pub. Date: Oct. 29, 2026

(54) Electronic Device and Movable Graphics Card Bracket

(71) Applicant: Cooler Master Technology Inc., Taipei City (TW)

(72) Inventors: Cheng LI, Hui Zhou City (CN); Yuqing Lyu, Hui Zhou City (CN)

(73) Assignee: Cooler Master Technology Inc., Taipei City (TW)

(21) Appl. No.: 19/310,097

(22) Filed: Aug. 26, 2025

(30) Foreign Application Priority Data
Apr. 25, 2025 (CN) 202510529216.5

(51) Int. Cl. G06F 1/185

(52) U.S. Cl. CPC G06F 1/185

(57) ABSTRACT

An electronic device is presented that includes a chassis with a panel, a motherboard mounted on the chassis, and a movable graphics card bracket. The bracket comprises a base frame secured to the panel and a first movable frame configured to mount a graphics card. The base frame includes at least two first guiding structures and a stopper surface disposed opposite the guiding structures, while the first movable frame includes at least two second guiding structures that engage the first guiding structures in a rail-and-slider configuration. This engagement permits the movable frame to slide in a first direction toward or away from the motherboard. The first guiding structures are equally spaced from the stopper surface, allowing the movable frame to be reversibly mounted to the base frame in either a typical or reversed orientation.

### CROSS-REFERENCE TO RELATED APPLICATIONS

This U.S. application claims the benefits of priority to Chinese application No. 202510529216.5, filed on Apr. 25, 2025, titled “Electronic Device and Movable Graphics Card Bracket” of which is incorporated herein by reference in its entirety.

### BACKGROUND

A graphics card is an extension card focused on a GPU (graphics processing unit) utilized in computers. Typically, one or more fans mounted on the card to dissipate heat from GPU. Fans on various graphics card models frequently have divergent air outlet orientations.

In general, the orientation and location of the graphics card mounted in a chassis cannot be adjusted. As a result, for some graphics card specifications, the fan’s airflow will be significantly impeded, causing waste heat to accumulate in the chassis and become difficult to dissipate.

### SUMMARY

The present disclosure relates to an electronic device and movable graphics card bracket, particularly to an electronic device including a movable graphics card bracket, which bracket can mount a graphics card onto a chassis.

Aspects of the present disclosure provide an electronic device. The electronic device includes a chassis having a panel and a motherboard mounted on the chassis. The device further includes a movable graphics card bracket comprising a base frame secured to the panel and a first movable frame configured to mount a graphics card. The base frame includes at least two first guiding structures and a stopper surface disposed opposite to the first guiding structures. The first movable frame includes at least two second guiding structures that engage with the corresponding first guiding structures in a rail-and-slider configuration, allowing the first movable frame to slide in a first direction toward or away from the motherboard. The first guiding structures are equally spaced from the stopper surface, enabling the first movable frame to be reversibly mountable to the base frame in either a typical or reversed orientation.

In one embodiment, the device further comprises a second movable frame configured to mount the graphics card, the first movable frame includes at least two third guiding structures, and the second movable frame includes at least two fourth guiding structures, and the third guiding structures engage with the corresponding fourth guiding structures in a rail-and-slider configuration, allowing the second movable frame to slide in a second direction perpendicular to the first direction.

In one embodiment, the first movable frame includes a first frame body, a first bottom plate, a top plate, and a first side plate, wherein the first bottom plate and the top plate are both connected to the first frame body, wherein the first side plate are connected to the first frame body, the first bottom plate, and the top plate, two of the second guiding structures are respectively disposed on the first bottom plate and the top plate, and wherein two of the third guiding structures are respectively disposed on the first bottom plate and the first side plate.

In one embodiment, the first side plate includes a first ventilation recess, the first ventilation recess includes a first groove bottom plate and a first groove side plate, the first groove bottom plate and the first groove side plate are adjacent to one another, the first groove bottom plate faces away from the first bottom plate and the first groove side plate faces away from the first frame body.

In one embodiment, the second movable frame includes a second frame body, a second bottom plate, and a second side plate, the second bottom plate and the second side plate are both connected to the second frame body, and two of the fourth guiding structures are respectively disposed on the second side plate and the second bottom plate.

In one embodiment, the second side plate includes a second ventilation recess, the second ventilation recess includes a second groove bottom plate and a second groove side plate, the second groove bottom plate and the second groove side plate are adjacent to one another, the second groove bottom plate faces away from the second bottom plate and the second groove side plate faces away from the second frame body.

In one embodiment, the device further comprises an adapter card disposed on the second bottom plate and configured to mount the graphics card.

In one embodiment, the second direction is angled with respect to a vertical direction.

In one embodiment, the device further comprises a support bracket disposed in the chassis and configured to support the graphics card.

In one embodiment, the support bracket includes a base plate mounted in the chassis, a first slide rail disposed on the base plate, a first slider slidably disposed on the first slide rail along the first direction, a second slide rail rotatably mounted on the first slider along a vertical direction perpendicular to the first direction, a second slider slidably disposed on the second slide rail along the vertical direction, and a support plate protruding from a side of the second slider opposite to the base plate and supporting the graphics card on the side opposite to the base frame.

In one embodiment, the panel includes a plurality of mounting holes configured to enable the base frame to be selectively secured in different vertical positions.

Another aspect of the present disclosure provides a movable graphics card bracket for mounting a graphics card to a chassis. The bracket includes a base frame having at least two first guiding structures and a stopper surface disposed opposite to the first guiding structures, the base frame being secured to a panel of a chassis. The bracket further includes a first movable frame having at least two second guiding structures. The corresponding first and second guiding structures form a rail-and-slider configuration, allowing the first movable frame to slide in a front-rear direction on the base frame. The first guiding structures are equally spaced from the stopper surface, enabling the first movable frame to be reversibly mountable to the base frame in either a typical or reversed orientation.

In one embodiment, the bracket further comprises a second movable frame configured to mount the graphics card, the first movable frame includes at least two third guiding structures, and the second movable frame includes at least two fourth guiding structures, and the third guiding structures engage with the corresponding fourth guiding structures in a rail-and-slider configuration, allowing the second movable frame to slide in a left-right direction perpendicular to the front-rear direction.

In one embodiment, the first movable frame includes a first frame body, a first bottom plate, a top plate, and a first side plate, the first bottom plate and the top plate are both connected to the first frame body, the first side plate is connected to the first frame body, the first bottom plate, and the top plate, two of the second guiding structures are respectively disposed on the first bottom plate and the top plate, and two of the third guiding structures are respectively disposed on the first bottom plate and the first side plate.

In one embodiment, the first side plate includes a first ventilation recess, the first ventilation recess includes a first groove bottom plate and a first groove side plate, the first groove bottom plate and the first groove side plate are adjacent to one another, the first groove bottom plate faces away from the first bottom plate and the first groove side plate faces away from the first frame body.

In one embodiment, the second movable frame includes a second frame body, a second bottom plate, and a second side plate, the second bottom plate and the second side plate are both connected to the second frame body, and two of the fourth guiding structures are respectively disposed on the second side plate and the second bottom plate.

In one embodiment, the second side plate includes a second ventilation recess, the second ventilation recess includes a second groove bottom plate and a second groove side plate, the second groove bottom plate and the second groove side plate are adjacent to one another, the second groove bottom plate faces away from the second bottom plate and the second groove side plate faces away from the second frame body.

In one embodiment, the bracket further comprises an adapter card disposed on the second bottom plate and configured to mount the graphics card.

In one embodiment, the bracket further comprises a support bracket disposed in the chassis and configured to support the graphics card on a side of the graphics card opposite to the base frame.

In one embodiment, the support bracket includes a base plate mounted in the chassis, a first slide rail disposed on the base plate, a first slider slidably disposed on the first slide rail along the front-rear direction, a second slide rail rotatably mounted on the first slider along a vertical direction perpendicular to the front-rear direction, a second slider slidably disposed on the second slide rail along the vertical direction, and a support plate protruding from a side of the second slider opposite to the base plate and supporting the graphics card on the side opposite to the base frame.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a perspective schematic view of an electronic device according to an embodiment of the present disclosure.

FIG. 2 is a partial enlarged view of a side view of the electronic device in FIG. 1.

FIG. 3 is an exploded view of the electronic device in FIG. 1.

FIG. 4 is another exploded view of the electronic device in FIG. 1.

FIG. 5 is yet another exploded view of the electronic device in FIG. 1, from another perspective.

FIG. 6 is a perspective schematic view of the support frame of the electronic device shown in FIG. 1.

FIG. 7 is a perspective schematic view of the electronic device according to an embodiment of the present disclosure, with a first movable plate mounted on a base frame.

FIG. 8 is an exploded view of the electronic device shown in FIG. 7.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

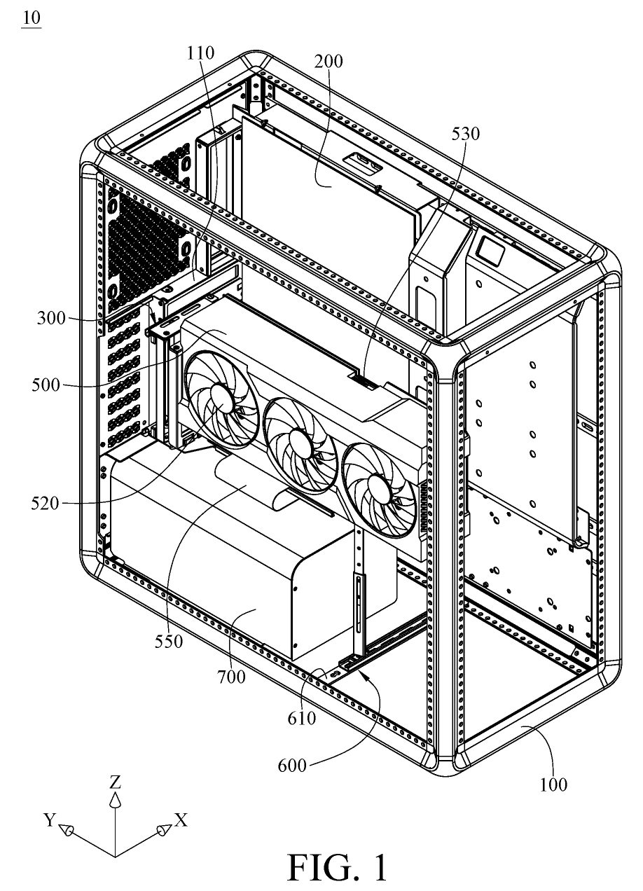

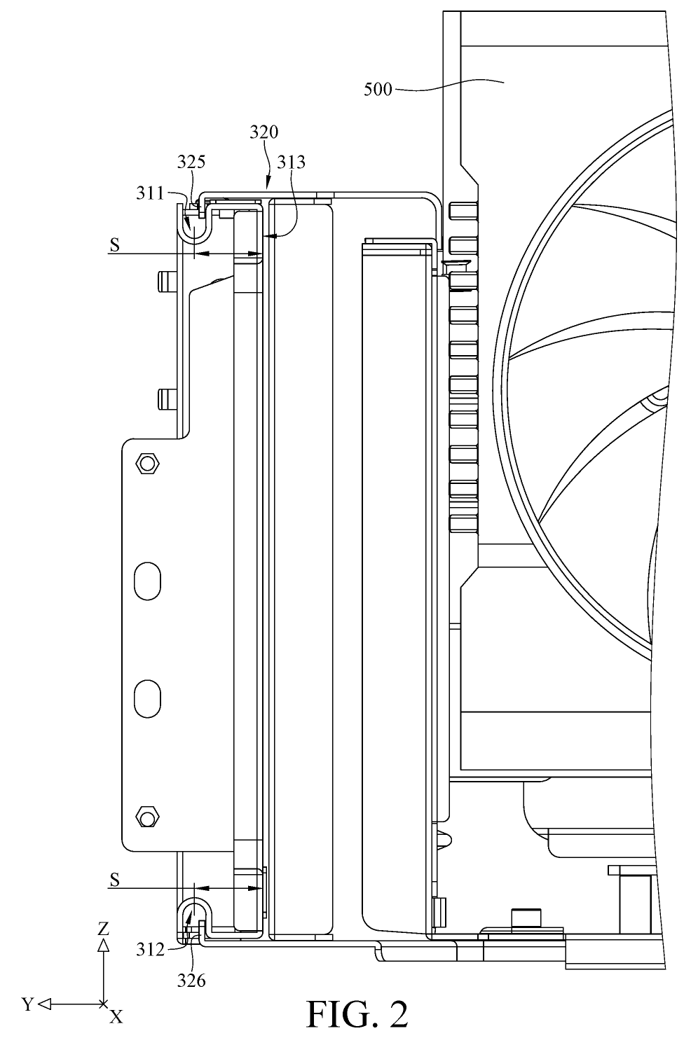

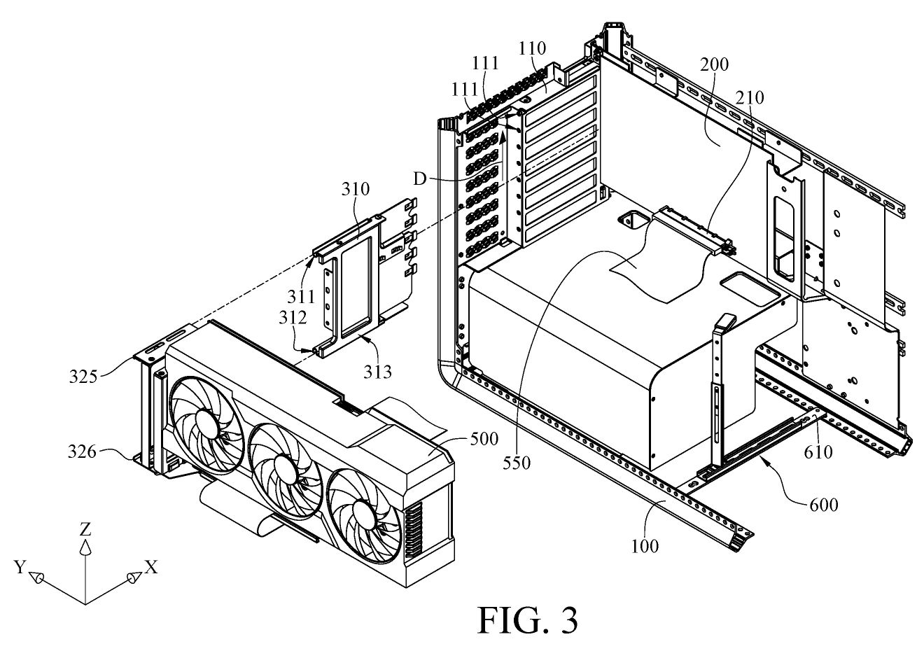

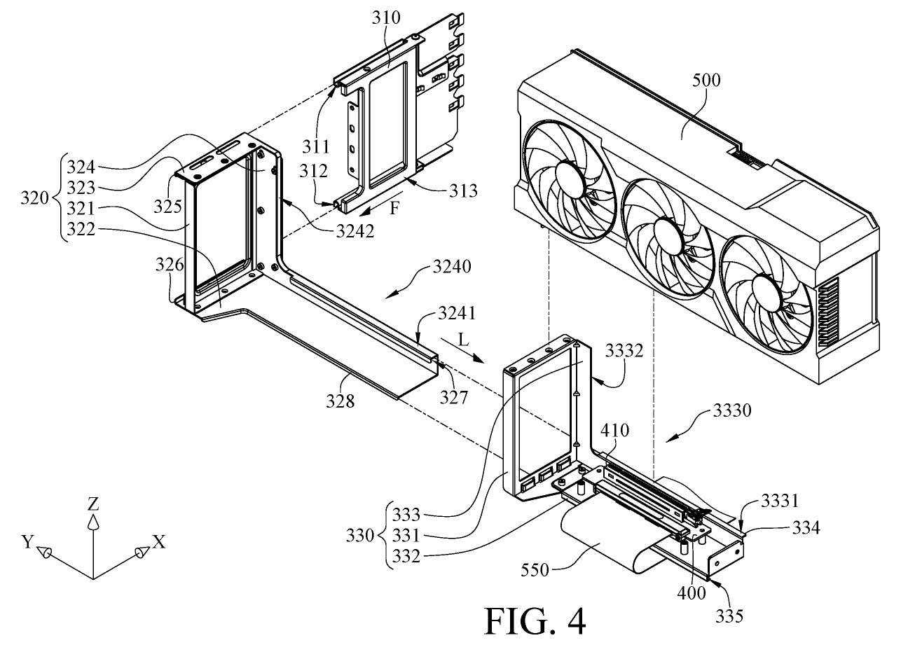

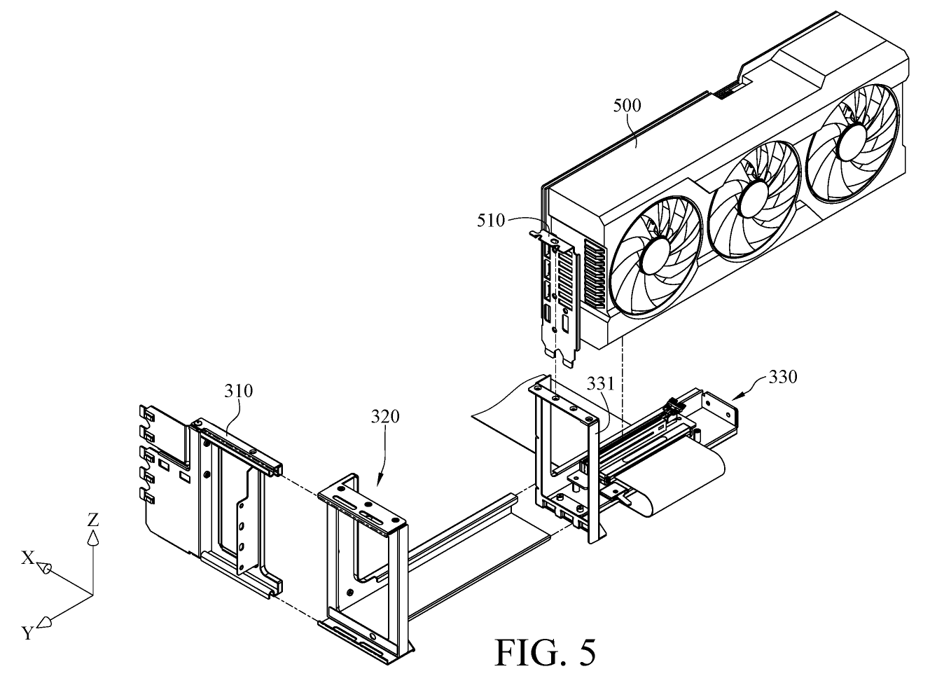

Please refer to FIGS. 1-5. FIG. 1 is a perspective schematic view of an electronic device according to an embodiment of the present disclosure. FIG. 2 is a partial enlarged view of a side view of the electronic device in FIG. 1. FIG. 3 is an exploded view of the electronic device in FIG. 1. FIG. 4 is another exploded view of the electronic device in FIG. 1. FIG. 5 is yet another exploded view of the electronic device in FIG. 1, from another perspective.

In this embodiment, the electronic device 10 is, for example, a computer host and includes a chassis 100, a motherboard 200, a movable graphics card bracket 300, an adapter card 400, a graphics card 500, and a support bracket 600.

The chassis 100 includes a panel 110. The motherboard 200 is installed within the chassis 100. The panel 110 may include an opening for installing I/O ports or for mounting the graphics card 500. The panel 110 is positioned on one side of the motherboard 200, for example, the front side.

In this embodiment, the movable graphics card bracket 300 includes a base frame 310, a first movable frame 320, and a second movable frame 330.

The base frame 310 is secured to the panel 110 of the chassis 100. For example, the base frame 310 is secured to the panel 110 via multiple mounting holes 111 on. By selecting different mounting holes 111, the vertical position of the base frame 310 along direction D (parallel to the Z-axis) can be adjusted. The base frame 310 includes at least two first guiding structures 311, 312 and a stopper surface 313. The stopper surface 313 is disposed opposite to the at least two first guiding structures 311, 312.

In this embodiment, the first movable frame 320 includes a first frame body 321, a first bottom plate 322, a top plate 323, and a first side plate 324. It also includes at least two second guiding structures 325, 326 and at least two third guiding structures 327, 328. The first bottom plate 322 and the top plate 323 are connected to opposite sides of the first frame body 321. The first side plate 324 are connected to the first frame body 321, the first bottom plate 322, and the top plate 323. The second guiding structures 325, 326 are located on the first bottom plate 322 and the top plate 323, respectively. The third guiding structures 328, 327 are located on the first bottom plate 322 and the first side plate 324, respectively.

The at least two first guiding structures 311, 312 and the at least two second guiding structures 325, 326 form matching rail-and-slider configurations. The second guiding structures 325, 326 are slidably disposed on the first guiding structures 311, 312, allowing the first movable frame 320 to slide along a front-rear direction F (parallel to the X-axis) relative to the base frame 310 or to slide toward and away from the motherboard 200. As shown in FIG. 2, the first guiding structures 311, 312 are equally spaced from the stopper surface 313, enabling the first movable frame 320 to be reversibly mounted to the base frame 310 in either a normal or reversed orientation. FIG. 1 illustrates the first movable frame 320 mounted in the normal orientation (i.e., second guiding structure 325 sliding on first guiding structure 311, and second guiding structure 326 sliding on first guiding structure 312). The reversed orientation will be detailed subsequently.

In this embodiment, the first guiding structures 311, 312 are, for example, rails, and the second guiding structures 325, 326 are sliders. However, the disclosure is not limited to this configuration. In other embodiments, for example, it could be opposite — the first guiding structures could be sliders and the second guiding structures could be rails.

Additionally, in this embodiment, the first side plate 324 includes a first ventilation recess 3240. The first ventilation recess 3240 includes a first groove bottom surface 3241 and a first groove side surface 3242 that are adjacent to one another. The groove bottom surface 3241 faces away from the first bottom plate 322, and the groove side surface 3242 faces away from the first frame body 321.

In this embodiment, the second movable frame 330 includes a second frame body 331, a second bottom plate 332, and a second side plate 333, and further includes at least two fourth guiding structures 334, 335. The second bottom plate 332 and the second side plate 333 are connected to the second frame body 331. The fourth guiding structures 334, 335 are located on the second side plate 333 and the second bottom plate 332, respectively.

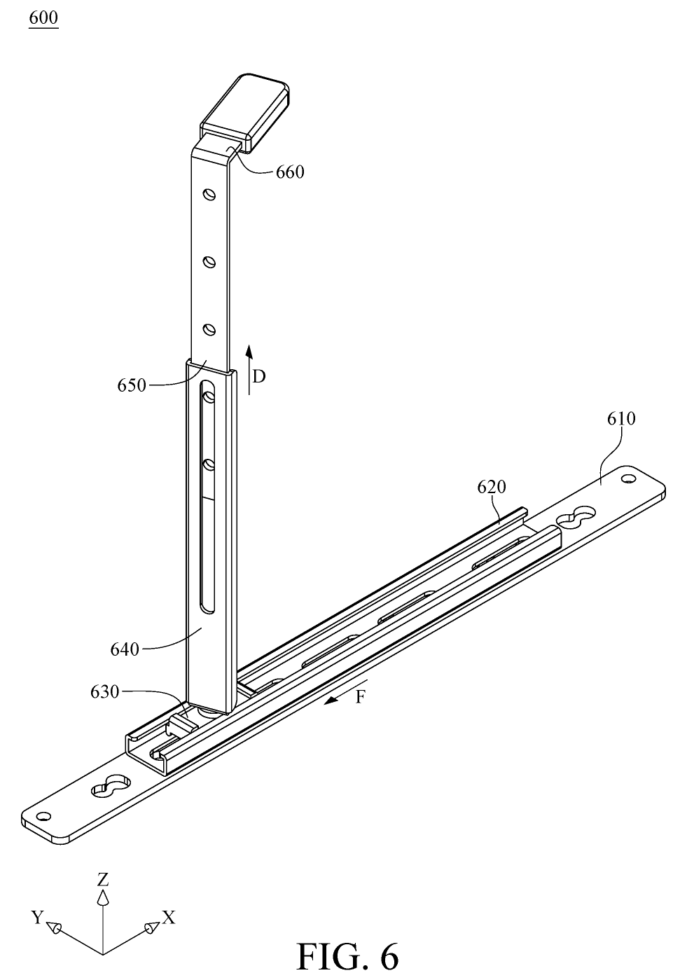

The third guiding structures 327, 328 and the fourth guiding structures 334, 335 form matching rail-and-slider configurations. The fourth guiding structures 334, 335 are slidably disposed on the third guiding structures 327, 328, allowing the second movable frame 330 to slide in a left-right direction L (parallel to the Y-axis) relative to the first movable frame 320. The left-right direction L is perpendicular to both the front-rear direction F shown in FIGS. 4 and 6 and the vertical direction D shown in FIG. 6.

For example, one of the third guiding structures 327 may be a rail and the other 328 a slider, whereas one of the fourth guiding structures 334 may be a slider and the other 335 a rail. However, the disclosure is not limited to this configuration. In other embodiments, the types of third and fourth guiding structures may be swapped accordingly.

Additionally, in this embodiment, the second side plate 333 includes a second ventilation recess 3330. The second ventilation recess 3330 includes a second groove bottom surface 3331 and a second groove side surface 3332 that are adjacent to one another. The second groove bottom surface 3331 faces away from the second bottom plate 332, and the second groove side surface 3332 faces away from the second frame body 331.

The adapter card 400 is mounted on the second bottom plate 332. A fixing tab 510 of the graphics card 500 is mounted to the second frame body 331 of the second movable frame 330. In other words, the graphics card 500 is mounted to the first movable frame 320 via the second movable frame 330. The graphics card 500 is inserted into a connector 410 of the adapter card 400 and is electrically connected to the connector 210 of the motherboard 200 through the adapter card 400 and a flexible cable 550. In addition, a power connector 530 of the graphics card 500 may be electrically connected to a power supply 700 of the electronic device 10.

The incorporation of at least one of the ventilation recesses 3240 and 3330 on the first and second side plates 324 and 333 ensure that the movable graphics card bracket 300 does not impede airflow from the fans 520 mounted to the graphics card 500. This facilitates efficient heat dissipation by enabling the fans 520 to remove heat from the chassis 100.

Please refer to FIGS. 3 and 6. FIG. 6 is a perspective schematic view of the support frame of the electronic device shown in FIG. 1. The support bracket 600 is mounted in the chassis 100 and supports the graphics card 500 on the side opposite to the base frame 310. In this embodiment, the support bracket 600 includes a base plate 610, a first slide rail 620, a first slider 630, a second slide rail 640, a second slider 650, and a support plate 660. The base plate 610 is secured to the chassis 100. The first slide rail 620 is disposed on the base plate 610. The first slider 630 is slidably disposed along the front-rear direction F on the first slide rail 620. The second slide rail 640 is rotatably mounted on the first slider 630 along the vertical direction D. The second slider 650 is slidably disposed along the vertical direction D on the second slide rail 640. The support plate 660 extends from the side of the second slider 650 opposite to the base plate 610, supporting the graphics card 500 on the side away from the base frame 310.

The support bracket 600 prevents sagging of the graphics card 500 on the side opposite to the base frame 310 (e.g., along the negative Z-axis) c, allowing the graphics card 500’s reliable installation within the chassis 100. This is beneficial for embodiments where the first side plate 324 includes the first ventilation recess 3240 or the second side plate 333 includes the second ventilation recess 3330. In such cases, the cutout design of the side plates 324 and 333 may not be able to provide sufficient support, and the support bracket 600 compensates for this deficit.

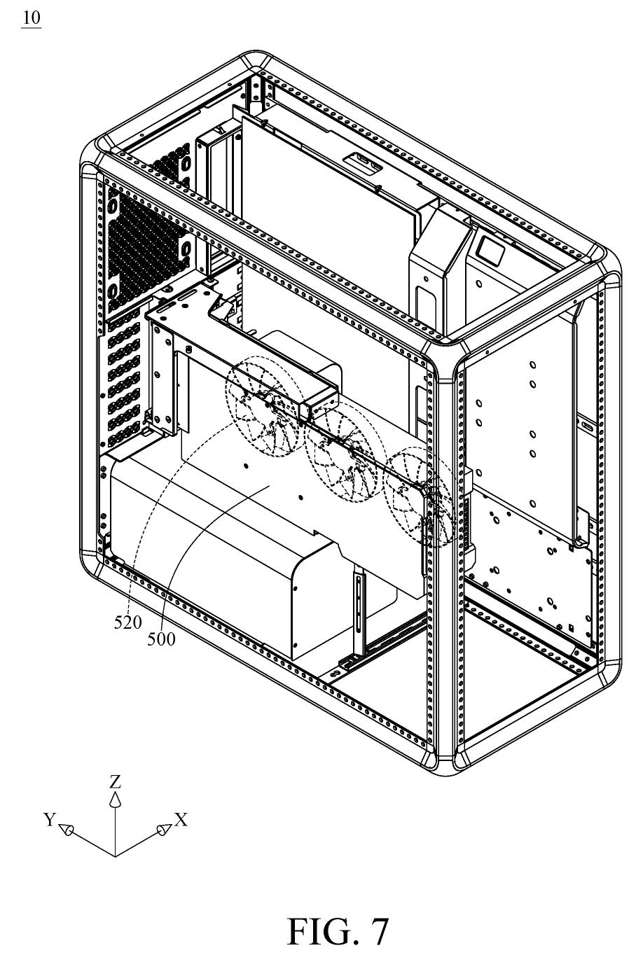

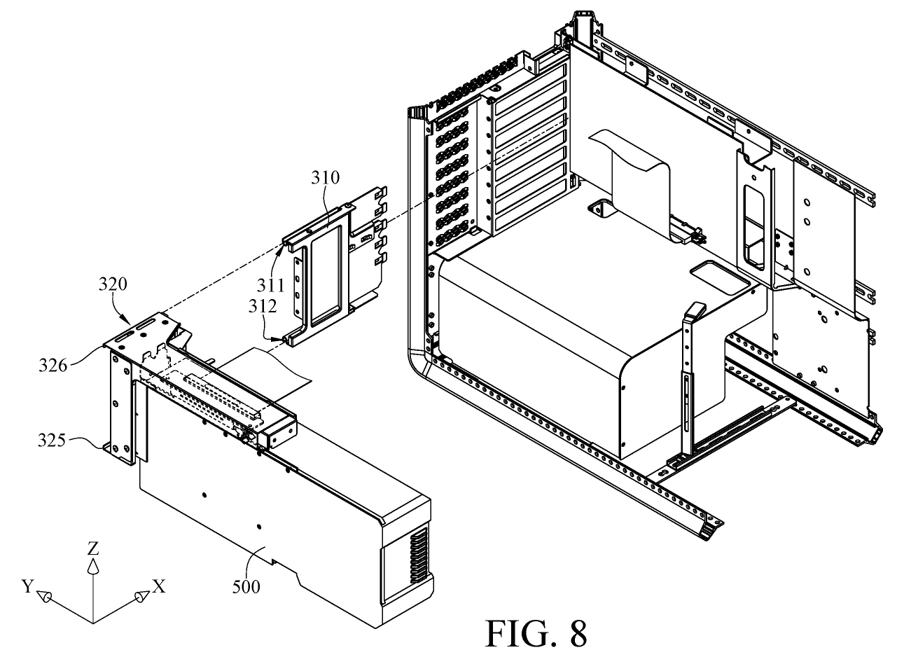

Please refer to FIGS. 7 and 8. FIG. 7 is a perspective schematic view of the electronic device according to another embodiment of the present disclosure, with a first movable plate mounted on a base frame. FIG. 8 is an exploded view of the electronic device shown in FIG. 7. Compared to the previous embodiment illustrated above, FIGS. 7 and 8 illustrate an example where the first movable frame 320 is mounted in reverse to the base frame 310 (i.e., second guiding structure 325 is slidably disposed on first guiding structure 312, and second guiding structure 326 is on guiding structure 311). As stated, switching from typical to reversed orientation changes the mounting direction of the first movable frame 320, which changes the airflow direction of the graphics card 500. This allows the user to choose the ideal mounting direction based on the fan 520’s air direction for the efficient dissipation of waste heat from the chassis 100.

Additionally, as shown in FIGS. 6 and 7, the support plate 660 of the support bracket 600 can be adjusted via the first slide rail 620, first slider 630, second slide rail 640, and second slider 650 to position the graphics card 500 appropriately relative to the base frame 310, e.g., opposite to the base frame 310.

According to the above-described electronic device 10 and movable graphics card bracket 300, because the at least two first guiding structures 311, 312 are equally spaced from the stopper surface 313, the first movable frame 320 can be mounted in either a typical or reversed orientation. This allows the user to adjust the installation direction according to the airflow of the graphics card’s fan 520, so ensuring effective heat dissipation from the chassis 100. Furthermore, a movable graphics card bracket 300 is provided, configured to secured a graphics card 500 to a chassis 100.

In some embodiments, the movable graphics card bracket 300 comprises a base frame 310 having at least two first guiding structures 311, 312 and a stopper surface 313 disposed opposite to the first guiding structures 311, 312. The base frame 310 is secured to a panel 110 of the chassis 100. A first movable frame 320 is provided with at least two second guiding structures 325, 326, which correspond to the first guiding structures 311, 312 to form rail-and-slider pairs. This configuration allows the first movable frame 320 to be slidably mounted to the base frame 310 along a front-rear direction F and move toward or away from the motherboard 200, enabling adjustment of the graphics card 500 position relative to either the chassis 100 or motherboard 200. The two first guiding structures 311, 312 are equally spaced from the stopper surface 313, allowing the first movable frame 320 to be reversibly mounted in either a typical or reversed orientation. The movable graphics card bracket 300 provides enhanced flexibility for thermal management and mechanical stability in compact or high-performance electronic devices 10 through reversible installation and multi axis adjustment.

Therefore, embodiments disclosed herein are well adapted to attain the ends and advantages mentioned as well as those that are inherent therein. The embodiments disclosed above are illustrative only, as the embodiments disclosed may be modified and practiced in different but equivalent manners apparent to those of ordinary skill in the relevant art having the benefit of the teachings herein. Furthermore, no limitations are intended to the details of construction or design herein shown, other than as described in the claims below. It is therefore evident that the illustrative embodiments disclosed above may be altered, combined, or modified and all such variations are considered within the scope and spirit of the present disclosure. Of course, the disclosed embodiments are merely exemplary embodiments and that various modifications can be made without departing from the spirit and scope of the disclosure. Further, it should be understood that various aspects of the embodiment are not mutually exclusive of each other and can be combined as desired by a person of ordinary skill in the art as a matter of design choices.

The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some number. Whenever a numerical range with a lower limit and an upper limit is disclosed, any number and any included range falling within the range is specifically disclosed. Every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

What is claimed is:

1. An electronic device comprising:
a chassis having a panel;
a motherboard mounted on the chassis; and
a movable graphics card bracket including:
a base frame secured to the panel, the base frame having at least two first guiding structures and a stopper surface disposed opposite to the first guiding structures; and
a first movable frame configured to mount a graphics card, the first movable frame having at least two second guiding structures that engage with the corresponding first guiding structures in a rail-and-slider configuration, allowing the first movable frame to slide in a first direction toward or away from the motherboard,
wherein the first guiding structures are equally spaced from the stopper surface, enabling the first movable frame to be reversibly mountable to the base frame in either a typical or reversed orientation.

2. The device of claim 1, further comprising a second movable frame configured to mount the graphics card,
wherein the first movable frame includes at least two third guiding structures, and the second movable frame includes at least two fourth guiding structures, and wherein the third guiding structures engage with the corresponding fourth guiding structures in a rail-and-slider configuration, allowing the second movable frame to slide in a second direction perpendicular to the first direction.

3. The device of claim 2, wherein the first movable frame includes a first frame body, a first bottom plate, a top plate, and a first side plate, wherein the first bottom plate and the top plate are both connected to the first frame body, wherein the first side plate are connected to the first frame body, the first bottom plate, and the top plate,
wherein two of the second guiding structures are respectively disposed on the first bottom plate and the top plate, and wherein two of the third guiding structures are respectively disposed on the first bottom plate and the first side plate.

4. The device of claim 3, wherein the first side plate includes a first ventilation recess,
wherein the first ventilation recess includes a first groove bottom plate and a first groove side plate, wherein the first groove bottom plate and the first groove side plate are adjacent to one another, wherein the first groove bottom plate faces away from the first bottom plate and the first groove side plate faces away from the first frame body.

5. The device of claim 2, wherein the second movable frame includes a second frame body, a second bottom plate, and a second side plate, wherein the second bottom plate and the second side plate are both connected to the second frame body, and wherein two of the fourth guiding structures are respectively disposed on the second side plate and the second bottom plate.

6. The device of claim 5, wherein the second side plate includes a second ventilation recess, wherein the second ventilation recess includes a second groove bottom plate and a second groove side plate, wherein the second groove bottom plate and the second groove side plate are adjacent to one another, wherein the second groove bottom plate faces away from the second bottom plate and the second groove side plate faces away from the second frame body.

7. The device of claim 6, further comprising an adapter card disposed on the second bottom plate and configured to mount the graphics card.

8. The device of claim 2, wherein the second direction is angled with respect to a vertical direction.

9. The device of claim 1, further comprising a support bracket disposed in the chassis and configured to support the graphics card.

10. The device of claim 9, wherein the support bracket includes:
a base plate mounted in the chassis;
a first slide rail disposed on the base plate;
a first slider slidably disposed on the first slide rail along the first direction;
a second slide rail rotatably mounted on the first slider along a vertical direction perpendicular to the first direction;
a second slider slidably disposed on the second slide rail along the vertical direction; and
a support plate protruding from a side of the second slider opposite to the base plate and supporting the graphics card on the side opposite to the base frame.

11. The device of claim 1, wherein the panel includes a plurality of mounting holes configured to enable the base frame to be selectively secured in different vertical positions.

12. A movable graphics card bracket for mounting a graphics card to a chassis, comprising:
a base frame having at least two first guiding structures and a stopper surface disposed opposite to the first guiding structures, the base frame being secured to a panel of a chassis; and
a first movable frame having at least two second guiding structures, the corresponding first and second guiding structures forming a rail-and-slider configuration, allowing the first movable frame to slide in a front-rear direction on the base frame,
wherein the first guiding structures are equally spaced from the stopper surface, enabling the first movable frame to be reversibly mountable to the base frame in either a typical or reversed orientation.

13. The bracket of claim 12, further comprising a second movable frame configured to mount the graphics card,
wherein the first movable frame includes at least two third guiding structures, and the second movable frame includes at least two fourth guiding structures, and wherein the third guiding structures engage with the corresponding fourth guiding structures in a rail-and-slider configuration, allowing the second movable frame to slide in a left-right direction perpendicular to the front-rear direction.

14. The bracket of claim 13, wherein the first movable frame includes a first frame body, a first bottom plate, a top plate, and a first side plate, wherein the first bottom plate and the top plate are both connected to the first frame body, wherein the first side plate is connected to the first frame body, the first bottom plate, and the top plate,
wherein two of the second guiding structures are respectively disposed on the first bottom plate and the top plate, and wherein two of the third guiding structures are respectively disposed on the first bottom plate and the first side plate.

15. The bracket of claim 14, wherein the first side plate includes a first ventilation recess,
wherein the first ventilation recess includes a first groove bottom plate and a first groove side plate, wherein the first groove bottom plate and the first groove side plate are adjacent to one another, and wherein the first groove bottom plate faces away from the first bottom plate and the first groove side plate faces away from the first frame body.

16. The bracket of claim 13, wherein the second movable frame includes a second frame body, a second bottom plate, and a second side plate, wherein the second bottom plate and the second side plate are both connected to the second frame body, and wherein two of the fourth guiding structures are respectively disposed on the second side plate and the second bottom plate.

17. The bracket of claim 16, wherein the second side plate includes a second ventilation recess, wherein the second ventilation recess includes a second groove bottom plate and a second groove side plate, wherein the second groove bottom plate and the second groove side plate are adjacent to one another, wherein the second groove bottom plate faces away from the second bottom plate and the second groove side plate faces away from the second frame body.

18. The bracket of claim 17, further comprising an adapter card disposed on the second bottom plate and configured to mount the graphics card.

19. The bracket of claim 12, further comprising a support bracket disposed in the chassis and configured to support the graphics card on a side of the graphics card opposite to the base frame.

20. The bracket of claim 19, wherein the support bracket includes:
a base plate mounted in the chassis;
a first slide rail disposed on the base plate;
a first slider slidably disposed on the first slide rail along the front-rear direction;
a second slide rail rotatably mounted on the first slider along a vertical direction perpendicular to the front-rear direction;
a second slider slidably disposed on the second slide rail along the vertical direction; and
a support plate protruding from a side of the second slider opposite to the base plate and supporting the graphics card on the side opposite to the base frame.
